(19) United States
(12) Patent Application Publication
(10) Pub. No.: US 2024/0247581 A1
(43) Pub. Date: Jul. 25, 2024

(54) SYSTEM AND METHOD FOR TRACKING A STATE OF DISSOLVABLE DOWNHOLE TOOLS

(71) Applicant: Kureha America, Inc., Houston, TX (US)

(72) Inventors: Shunsuke Abe, Houston, TX (US); Mayu Komatsu, Houston, TX (US); Shinya Takahashi, Houston, TX (US)

(73) Assignee: Kureha America, Inc., Houston, TX (US)

(21) Appl. No.: 18/545,737

(22) Filed: Dec. 19, 2023

Related U.S. Application Data
(60) Provisional application No. 63/440,708, filed on Jan. 24, 2023.

(51) Int. Cl. E21B 47/00; E21B 29/00; E21B 33/12; E21B 43/26; G01N 21/64

(52) U.S. Cl. CPC E21B 47/00; E21B 33/1208; E21B 43/26; G01N 21/6428; E21B 29/002; E21B 2200/08; G01N 2021/6439

(57) ABSTRACT

A tracer tool for tracking a state of a dissolvable downhole tool includes a medium dissolvable under downhole conditions, and at least one tracer material embedded in the medium, and releasable from the medium during dissolution of the medium. The tracer tool is mechanically separate from the dissolvable downhole tool.

### CROSS-REFERENCES TO RELATED APPLICATIONS

This application claims the benefit of priority under 35 U.S.C. § 119(e) to U.S. Provisional Patent Application Ser. No. 63/440,708, filed on Jan. 24, 2023, which is incorporated by referenced herein in its entirety.

### BACKGROUND

Hydraulic fracturing is widely conducted as an effective wellbore stimulation method, not only for unconventional reservoirs, but also for conventional oil/gas wells. With recent technological developments, the number of stages of fracturing has been increasing. In multi-stage fracturing, a frac plug (i.e., a zonal isolation device) is deployed to maximize the hydraulic pressure to generate fractures in a targeted zone. Traditionally, composite frac plugs consisting of non-dissolvable material such as epoxy and cast iron are used. This typically requires a mill-out process followed by retrieving debris of the frac plug before starting hydrocarbons production.

A dissolvable frac plug made of dissolvable material was recently developed. The dissolvable frac plug provides pressure tolerance during the fracturing operation, followed by a degradation after completion of the fracturing operation, thereby eliminating the need for the mill-out process.

However, it may be challenging to accurately predict the timing of the dissolution of the frac plug. Accordingly, the timing for beginning production or the potential need for milling out an incompletely dissolving or non-dissolving frac plug is unclear. Measurement of the wellbore fluid temperature profile which, to a significant degree, governs dissolution of the frac plug, is challenging. Accordingly, alternative solutions to estimating the timing of complete dissolution of frac plugs especially deployed at the heel-section of the well, in the most recently fractured zone, are highly desirable.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In general, in one aspect, embodiments relate to a tracer tool for tracking a state of a dissolvable downhole tool, the tracer tool comprising: a medium dissolvable under downhole conditions; and at least one tracer material embedded in the medium, and releasable from the medium during dissolution of the medium, wherein the tracer tool is mechanically separate from the dissolvable downhole tool.

In general, in one aspect, embodiments relate to a method for tracking a state of a dissolvable downhole tool, the method comprising: deploying a tracer tool in a downhole outfitted with the dissolvable downhole tool, wherein the tracer tool comprises: a medium dissolvable under downhole conditions, and at least one tracer material embedded in the medium, and releasable from the medium during dissolution of the medium, and wherein the tracer tool is mechanically separate from the dissolvable downhole tool; performing a hydraulic fracturing operation; determining the state of the dissolvable downhole tool by monitoring an emission spectrum of a flowback from the downhole to detect a presence of the at least one tracer material; and based on the determining of the state, decide on a completion operation to be performed on the downhole.

In general, in one aspect, embodiments relate to a system for tracking a state of a dissolvable downhole tool, the system comprising: a tracer tool comprising: a medium dissolvable under downhole conditions; and at least one tracer material embedded in the medium, and releasable from the medium during dissolution of the medium, wherein the tracer tool is mechanically separate from the dissolvable downhole tool; and an interrogator unit for detecting a presence of the at least one tracer material in a flowback from the downhole.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIG. 1 shows a hydraulic fracturing scenario in accordance with one or more embodiments.

FIG. 2 shows a system for tracing degradation of frac plugs in accordance with embodiments of the invention.

FIG. 3 shows a method in accordance with one or more embodiments.

FIG. 4 shows a computer system in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

In general, embodiments of the disclosure relate to a systems and methods for tracking the state of dissolvable downhole tools. In one or more embodiments, a tracer tool that releases tracer materials is disposed in the downhole to track the degree of dissolution of a downhole tool. The tracking of the dissolution may be performed from the surface. A detailed description is subsequently provided.

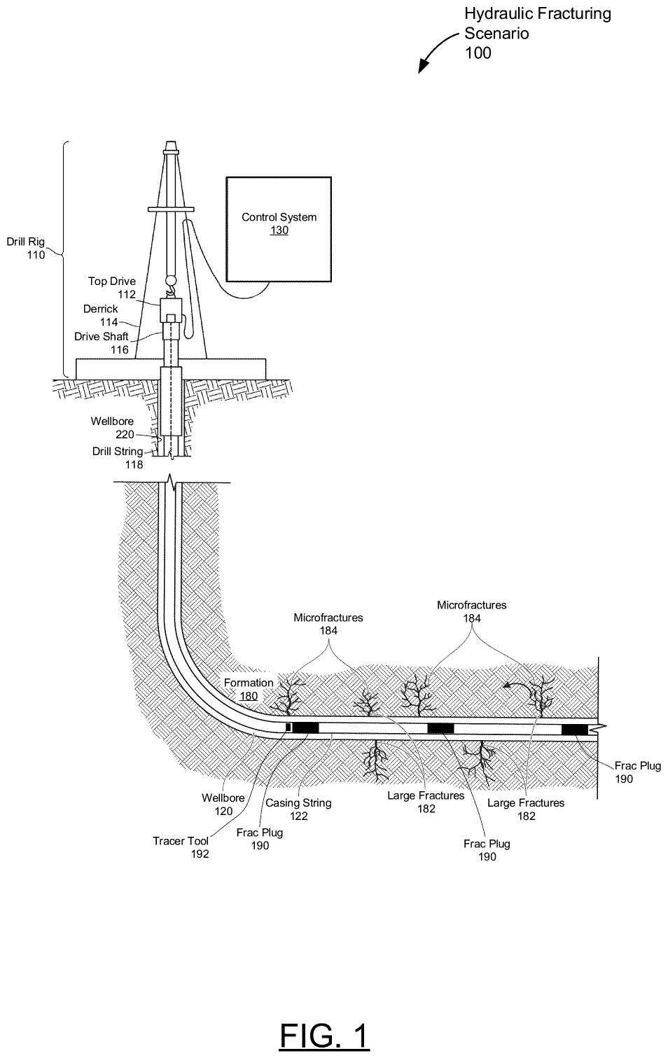

FIG. 1 schematically shows a hydraulic fracturing scenario in accordance with one or more embodiments. The example shows a drill rig (110) including a top drive (112) that may be suspended in a derrick (114). In the center of the top drive (112), a drive shaft (116) may be coupled to a drill string (118). The top drive (112) may rotate the drive shaft (116), and any downhole tool (not shown) at the bottom end of the drill string (118). For example, a drill bit may have been attached to the drill string (118) to drill the wellbore (120). A control system (130) may be used to control the operation for the drill rig (110), including the drilling of the wellbore. The control system may also control various hydraulic operations such as a hydraulic fracturing, described below. The control system (130) may include one or more programmable logic controllers (PLCs) or other types of computer devices that include hardware and/or software with functionality to control one or more processes performed by the drilling system (300), a hydraulic stimulation operation, and/or a well completion assembly. Specifically, for example, a programmable logic controller may control valve states, fluid levels, pipe pressures, warning alarms, and/or pressure releases throughout a well network, such as one connected to a drilling rig. Without loss of generality, the term “control system” may refer to an operation control system that is used to operate and control the equipment, a data acquisition and monitoring system that is used to acquire equipment data and to monitor the operation of a drilling process, a hydraulic stimulation process, or a well completion process. A control system may also include interpretation software system that is used to analyze and understand drilling events, well completion events, and hydraulic stimulation events and their respective progress.

In the example of FIG. 1, the drilling of the wellbore (120) into the formation (180) has been completed, and a casing string (122) has been positioned within the wellbore (120). In the formation (180), hydrocarbon reserves may be trapped within certain low permeability formations, such as sand, carbonate, and/or shale formations. Thus, stimulation treatments may enhance well productivity at one or more wells, where one type of stimulation treatment is hydraulic fracturing. Hydraulic fracturing may involve injecting high viscosity fluids into the wellbore (120) at a sufficiently high injection rate so that enough pressure is produced within the wellbore to split the formation. As FIG. 1 illustrates, the hydraulic fracturing may result in the formation of large fractures (182) and microfractures (184).

One or more techniques may be used to ensure that an induced fracture becomes conductive after injection ceases. For example, during acid fracturing of carbonate formations, acid-based fluids may be injected into the formation (180) to create an etched fracture and conductive channels. These conductive channels may be left open upon closure of the induced fracture. With sand or shale formations, a proppant may be included with the hydraulic fracturing fluid such that the induced fracture remains open during or following a stimulation treatment. Likewise, in carbonate formations, a stimulation treatment may include both acid fracturing fluids and proppants. Accordingly, heat produced within a formation, acid, or aqueous water transmitted into the formation may all play a role in producing reactions causing one or more microfractures in a formation.

Keeping with hydraulic fracturing, a hydraulic fracturing fluid may be pumped through the casing string (122) and into a targeted formation using various perforations (i.e., open holes) in the casing string (122). By injecting the hydraulic fracturing fluid at pressures high enough to cause the rock within the targeted formation to fracture, the hydraulic fracturing operation may “break down” the formation. As high-pressure fluid injection continues, a fracture may continue to propagate into a fracture network. Once a desired fracture network is formed, the fluid flow may be reversed, and the liquid portion of the fracturing fluid is removed. The proppant may be left behind to prevent the fractures from closing onto themselves due to the weight and stresses within the formation. Accordingly, the proppant may “prop” or support the induced fractures to remain open, by remaining sufficiently permeable for hydrocarbon fluids to flow through the induced fracture. Thus, a proppant may form a packed bed of particles with interstitial void space connectivity within a formation.

In one or more embodiments, the hydraulic fracturing is performed in stages. Specifically, a prescribed section of the wellbore (120) drilled and completed in a subterranean formation several thousand meters deep may be partially plugged using frac plugs (190) to sequentially isolate zones of the wellbore (120). In one or more embodiments, a frac plug (190) forms a hydraulic seal during the hydraulic fracturing operation. The frac plug is designed to withstand high hydraulic pressure, e.g., up to 10,000 psi to maintain a pressure necessary to produce fractures in the formation (180) in the targeted zone of the wellbore hydraulically delimited by the frac plug. The zonal isolation may maximize the hydraulic pressure that may be applied in the targeted zone to generate fractures. Fluid may, thus, be fed at high pressure into the individual plugged zones to produce fractures in different zones of the formation (180). Using the frac plugs (190) the local hydraulic fracturing may be repeated for different zones along the wellbore (120), starting from the tip portion of the wellbore and proceeding in the direction of the ground surface. Any number of stages may be implemented using frac plugs. For example, up to 50, 80, or more stages may be used.

The frac plug (190) may be designed to be transported to its desired location in the wellbore (120), e.g., in a hydraulic flow. When the frac plug (190) reaches its designated location, a signal may be sent from the surface to cause the frac plug (190) to change its shape, e.g., by causing metallic plates to expand, thereby fixating the frac plug (190) inside the wellbore (120) while a rubber seal material radially outwardly expands to establish a solid hydraulic seal.

After the completion of the hydraulic fracturing, it may be necessary to remove the frac plugs (190). In one or more embodiments, the frac plugs (190) are dissolvable. The frac plugs (190) may be made of or may include a dissolvable material. Unlike traditional composite frac plugs consisting of non-dissolvable material such as epoxy and cast iron which require a milling out process followed by retrieving debris of the tool before starting hydrocarbons production, frac plugs (190) in accordance with embodiments of the disclosure may dissolve on their own, over time. Frac plugs (190) in accordance with embodiments of the disclosure, thus, are more economical than conventional plugs by eliminating the mill-out process associated with conventional frac plugs.

In one or more embodiments, the frac plugs (190) include a dissolvable material such as polyglycolic acid (PGA). The material may have a high initial mechanical strength for at least the duration of the hydraulic fracturing, thereby being able to withstand high hydraulic pressures. For example, depending on the type of dissolvable material, a frac plug (190) may withstand hydraulic pressure for a hydraulic fracturing time interval of ten hours. After the hydraulic fracturing time interval, the dissolvable material may begin to degrade, thereby becoming mechanically weaker. The degrading of the material may occur over a degrading time interval of, for example two to four days. After the degrading time interval, the frac plug (190) may have dissolved to a degree allowing a hydraulic flow past the frac plug. Accordingly, production of hydrocarbons may begin.

The timing of the degrading of the frac plug (190) (including the length of the hydraulic fracturing time interval and the length of the degrading time interval) may depend on various factors. Degradation may accelerate with higher temperatures. Accordingly, the frac plug (190) may remain mechanical strong while relatively cold fluids are injected for the hydraulic fracturing. When the injection stops, the fluids in the wellbore (120) and the frac plug (190) may heat up to reach the prevailing temperature of the formation (180). This temperature tends to be considerably higher than the temperature of the originally injected fluids, thereby accelerating degradation. Further, the presence of certain chemicals, acting as solvents, may accelerate the degradation of the frac plug (190). In addition, mechanically shorter frac plugs may degrade faster than mechanically longer frac plugs in the wellbore (120). Also, different materials that may be used for the frac plug may degrade at different rates.

Various benefits may result from the use of degrading frac plugs in accordance with embodiments of the disclosure has various benefits. For example, time-consuming and costly drilling out of the frac plugs prior to production is no longer necessary. Further, with the elimination of drill-out operations, the length of the wellbore may be extended beyond the range that would otherwise be reachable with a drill bit.

In one or more embodiments, one or more tracer tools (192) are inserted into the wellbore (120) in order to track the degradation or dissolution of the frac plugs (190). The tracer tool may be deployed in the wellbore at the heel-section (i.e., the most recently fractured zone), as illustrated in FIG. 1.

Knowledge of the state of dissolution is beneficial because a degree of dissolution, sufficient to enable hydraulic flow, is necessary to begin production. The tracer tool (192) provides an indication of the degree of dissolution over time, that would otherwise be uncertain. The results obtained from the tracer tool(s) may be used to decide on the steps to be performed towards production. For example, the beginning of production may be scheduled based on the degree of dissolution indicated by the tracer tool(s). In addition, if insufficient degradation over time is detected, a decision may be made to mill out the remaining frac plug(s).

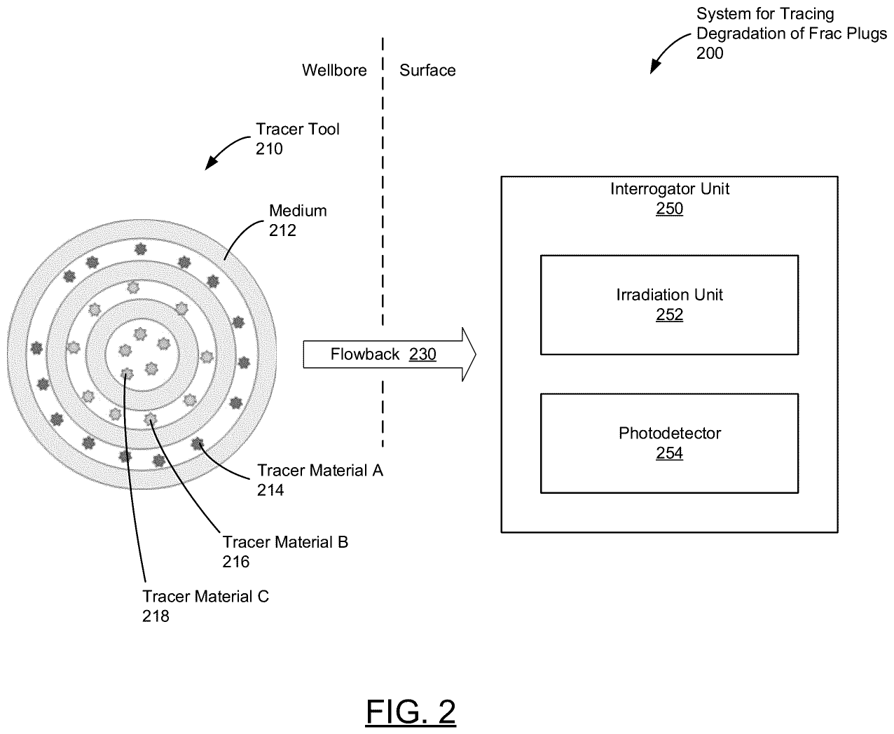

A detailed description of the tracer tool is provided in reference to FIG. 2.

While FIG. 1 shows a particular hydraulic fracturing scenario, the disclosure is not limited to this scenario. Any kind of hydraulic fracturing scenario in any type of geological environment with any number of frac plugs is intended to be covered, without departing from the disclosure.

FIG. 2 shows a system for tracing degradation of frac plugs, in accordance with embodiments of the invention. The system (200) includes the tracer tool (210) and an interrogator unit (250).

The tracer tool (210) may be located in the wellbore, whereas the interrogator unit (250) may be located at the surface, e.g., at the wellhead. The tracer tool (210) may be inserted into the wellbore, along with the frac plug(s) (190) or shortly thereafter.

In one or more embodiments, the tracer tool includes a medium (212). The medium is dissolvable under downhole conditions and provides a matrix to hold one or more tracer materials. The tracer tool (210) in the example of FIG. 2 includes three tracer materials (214, 216, 218) embedded in the medium (212). These tracer materials may be, for example, inorganic quantum dots (such as ZnS, CdSe), carbon-based quantum dots, and perovskite quantum dots (such as CsPbCl₃, CsPbBr₃), etc. Caron-based quantum dots may include, for example, carbon quantum dots (CQDs), graphene quantum dots, graphene oxide quantum dots, etc. CQDs may be preferred in terms of being less harmful to the environment and cheaper. In one embodiment, the tracer materials include photo-emissive particles that have a peak emission wavelength in a range of 400-750 nm. In one embodiment, CQDs with an external quantum yield of at least 30% are used. In the example, the concentration of CQD in the medium (212) is set at a level that allows it to be detected by the interrogator unit (250) in a flowback (230) from the downhole. Additional details are provided below in the discussion of the interrogator unit (250)

In one or more embodiment, when multiple different tracer materials (214, 216, 218) are used, they are arranged in different sections of the tracer tool. More specifically, the tracer materials (214, 216, 218) may be geometrically arranged such that they are released sequentially, over time. In one embodiment, the tracer materials (214, 216, 218) are arranged in layers from the periphery of the tracer tool (210) to the center of the tracer tool (210), resulting in a sequential release of the tracer materials (214, 216, 218) over time. For example, in the tracer tool (210), tracer material A (214) is arranged towards the outside of the tracer tool, where the medium (212) would dissolve first. Tracer material B (216) is arranged in an intermediate layer of the medium (212) that would dissolve next. Tracer material C (218) is arranged towards the center of the tracer tool, that would be last to dissolve. The benefit of using multiple distinct tracer materials (214, 216, 218) that are separately arranged is that the dissolution progress may be tracked relatively accurately. For example, one may conclude that dissolution of the tracer tool (210) is almost complete when tracer material C (218) is detectable. On the other hand, when tracer material A is detectable, one may conclude that the dissolution of the tracer tool (210) is in an earlier stage.

The medium (212) may be any type of material capable of releasing the tracer material(s) (214, 216, 218) through erosion of the medium (212). In one or more embodiments, the medium (212) does not release the tracer material(s) through washout of the tracer material(s) from the matrix, i.e., the medium (212) prevents tracer material from leaching from the medium without dissolution of the medium. In other words, in order for the tracer material(s) (214, 216, 218) to be released, dissolution of the medium (212) is necessary. In one embodiment, the medium (212) is polyglycolic acid (PGA). However, any other material that releases the tracer material(s) via erosion may be used, without departing from the disclosure. For example, a metal alloy, degradable polymers or degradable elastomeric material may be used. Suitable metal alloys may include, but are not limited to, a magnesium alloy, an aluminum alloy, a copper alloy, a calcium alloy, or combinations thereof. Suitable examples of degradable polymers may include, but are not limited to, aliphatic polyesters, polylactic acid, polyglycolic acid, poly(F-caprolactones), poly(hydroxybutyrates), polybutylene succinate, polyethylene oxide, the copolymers or blends thereof. Suitable elastomeric materials may include, but are not limited to, urethane rubber, natural rubber, isoprene rubber, ethylene propylene rubber, butyl rubber, styrene rubber, acrylic rubber, aliphatic polyester rubber, chloroprene rubber, polyester-based thermoplastic elastomer, and polyamide-based thermoplastic elastomer, and combinations thereof. In one embodiment, the medium (212) is identical to the dissolvable material of the frac plug. The released tracer material(s) may be transported to the interrogator unit (250) by the flowback (230), i.e., process fluids that are collected at the surface after the hydraulic fracturing operations are completed. The flowback may include the hydraulic fracturing fluids, hydrocarbons, and the tracer material(s) (214, 216, 218) released from the tracer tool (210). The flowback (230) may be analyzed by the interrogator unit (250) in order to detect a possible presence of the tracer material(s). Accordingly, the dissolution of the tracer tool (210) may be estimated based on the presence of tracer material(s) in the flowback. The detectability of tracer material(s) in the flowback may depend on various characteristics, including the configuration of the interrogator unit (250). Concentrations of at least 50 parts per trillion (ppt), 500 ppt, 5 parts per million (ppm), 500 ppm, 10,000 ppm, etc., may be detectable. With the dissolution of the tracer tool (210) assumed to be occurring substantially simultaneously with the degradation of the frac plugs, readings obtained from the interrogator unit may be used to predict the degree of degradation of the frac plugs.

The tracer tool (210) may have any geometric shape. For example, the tracer tool (210) may have a ball shape or cylindrical shape, e.g., similar to the shape of a frac plug. A combination of the geometric shape of the tracer tool (210) and/or the medium (212) of the tracer tool may be selected such that the dissolution of the tracer tool (210) occurs substantially synchronously with the dissolution of the frac plug(s).

In one or more embodiments, the tracer tool (210) is a component mechanically separate from the frac plug. Alternatively, the tracer tool (210) may be mechanically attached to the frac plug. In either case, the tracer tool (210) may not be part of the component that establishes a hydraulic seal, in the wellbore. The separation of the tracer tool (210) from the frac plug provides various significant benefits. The pressure resistance required for the frac plug may not be required for the separate tracer tool. In addition, separating the tracer tool from the complex configuration of the frac plug may make the production of the tracer tool easier. Also, the tracer tool (210) is not limited to use in conjunction with a frac plug. Many other downhole tools may be designed to be dissolvable, and the use of the tracer tool (210) to track their dissolution widens the range of applications. Examples for dissolvable downhole tools include a frac plug, a frac ball, a sealing ball, a sliding sleeve, a packer, a bridge plug, a cement sleeve, a wiper, a pipe plug, an ICD plug, an AICD plug, or a similar wellbore isolation device.

The Interrogator unit (250) in one or more embodiments, includes components for detecting the presence of a tracer material (e.g., tracer materials A, B, and C (214, 216, 218) in the flowback (230). The configuration of the components used for the detection depends on the type of tracer material. For example, in case of CQDs being used, an irradiation unit (252) and a photodetector (254) may be used for the detection. The irradiation unit (252) may expose the flowback (230) to light (e.g., ultraviolet light). The photodetector (254) may capture the photo spectrum resulting from the exposure of the flowback (230) to the UV light. Each of the tracer materials (214, 216, 218) may have a characteristic emission spectrum, in response to the exposure to UV light. The emission spectrum may or may not be in the range of visible light. In one embodiment, the peak emission wavelength is in a range of 400-750 nm. When an emission with a wavelength characteristic for a particular tracer material is detected, this suggests presence of the tracer material in the flowback (230). Based on the detection of the tracer material, one may conclude that the section of the tracer tool (210) that includes the detected tracer material is in the process of dissolving. Monitoring of the actual condition in the wellbore is, thus, unnecessary.

Based on the degree of determined dissolution of the tracer tool (210), one may estimate the degree of dissolution of the frac plug(s). For example, based on a design where the tracer tool dissolves simultaneously with the frac plug(s), one may directly rely on the detection of tracer material in the flowback to estimate the degree of dissolution of the frac plug(s). In the above example, one may conclude that the well is close to being ready for production, once tracer material C (218) is detected. Alternatively, if the tracer materials (A, B, C) are not detected within an expected time interval, one may conclude that it is necessary to mill out the frac plugs because the dissolution of the frac plug (210) has not occurred as expected, e.g., due to environmental circumstances.

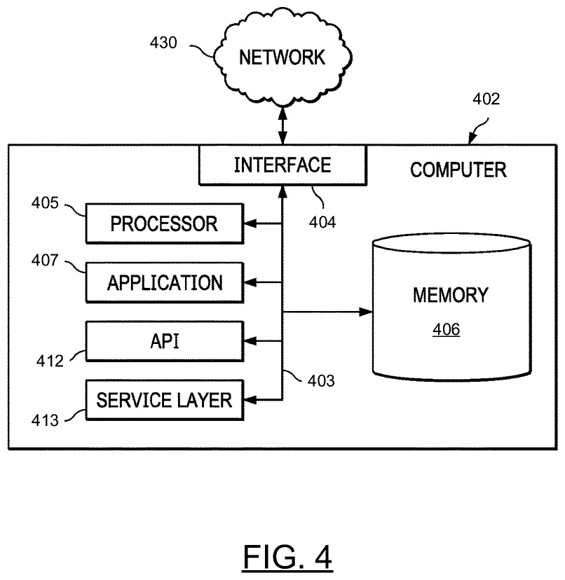

The interrogating, by the interrogator unit (250) may be performed either periodically, or continuously. For example, a sample of the flowback (230) may be analyzed once per hour, every few hours, etc. The interrogating may be performed either manually or automatically, e.g., controlled by a computer system as described in reference to FIG. 4. The computer system may document the detection of tracer materials (214, 216, 218) in the flowback (230) and may estimate the degree of dissolution of the frac plug, based on the presence of these tracer materials.

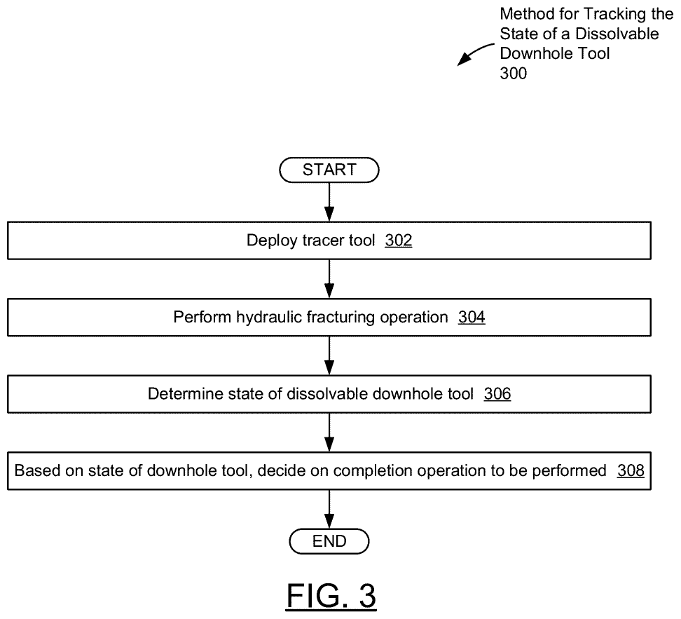

FIG. 3 shows a method (300) for tracking the state of a dissolvable downhole tool in accordance with one or more embodiments. More specifically, FIG. 3 describes the use of a tracer tool as previously described to indirectly, through tracking of the dissolution of the tracer tool, determine the state of dissolution of the downhole tool. While the various steps in FIG. 3 are presented and described sequentially, one of ordinary skill in the art will appreciate that some or all of the steps may be executed in different orders, may be combined or omitted, and some or all of the steps may be executed in parallel.

Prior to execution of the subsequently described steps, the dissolvable downhole tool, e.g., a frac plug, has been deployed.

In Step 302, the tracer tool is deployed in the downhole outfitted with the dissolvable downhole tool, as previously described.

In Step 304, a hydraulic fracturing operation is performed. The hydraulic fracturing operation may include multiple stages, as previously described. Alternatively, any other operation involving a dissolvable downhole tool may be performed.

In Step 306, the state of the dissolvable downhole tool is determined. The state may be determined by monitoring the emission spectrum of the backflow from the downhole. The monitoring may result in the detection of the presence of one or more tracer materials, as previously described. The state of the dissolvable downhole tool may be estimated based on the detection, as previously described.

In Step 308, a completion operation may be performed, based on the estimated state of the downhole tool. The completion operation may involve readying the downhole for production and/or milling out a remainder of the dissolvable downhole tool, as previously described.

Embodiments may be implemented on a computer system. FIG. 4 is a block diagram of a computer system (402) used to provide computational functionalities associated with described algorithms, methods, functions, processes, flows, and procedures as described in the instant disclosure, according to an implementation. The illustrated computer (402) is intended to encompass any computing device such as a high-performance computing (HPC) device, a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer (402) may include a computer that includes an input device, such as a keypad, keyboard, touch screen, or other device that can accept user information, and an output device that conveys information associated with the operation of the computer (402), including digital data, visual, or audio information (or a combination of information), or a GUI.

The computer (402) can serve in a role as a client, network component, a server, a database or other persistency, or any other component (or a combination of roles) of a computer system for performing the subject matter described in the instant disclosure. The illustrated computer (402) is communicably coupled with a network (430). In some implementations, one or more components of the computer (402) may be configured to operate within environments, including cloud-computing-based, local, global, or other environment (or a combination of environments).

At a high level, the computer (402) is an electronic computing device operable to receive, transmit, process, store, or manage data and information associated with the described subject matter. According to some implementations, the computer (402) may also include or be communicably coupled with an application server, e-mail server, web server, caching server, streaming data server, business intelligence (BI) server, or other server (or a combination of servers).

The computer (402) can receive requests over network (430) from a client application (for example, executing on another computer (402)) and responding to the received requests by processing the said requests in an appropriate software application. In addition, requests may also be sent to the computer (402) from internal users (for example, from a command console or by other appropriate access method), external or third-parties, other automated applications, as well as any other appropriate entities, individuals, systems, or computers.

Each of the components of the computer (402) can communicate using a system bus (403). In some implementations, any or all of the components of the computer (402), both hardware or software (or a combination of hardware and software), may interface with each other or the interface (404) (or a combination of both) over the system bus (403) using an application programming interface (API) (412) or a service layer (413) (or a combination of the API (412) and service layer (413). The API (412) may include specifications for routines, data structures, and object classes. The API (412) may be either computer-language independent or dependent and refer to a complete interface, a single function, or even a set of APIs. The service layer (413) provides software services to the computer (402) or other components (whether or not illustrated) that are communicably coupled to the computer (402). The functionality of the computer (402) may be accessible for all service consumers using this service layer. Software services, such as those provided by the service layer (413), provide reusable, defined business functionalities through a defined interface. For example, the interface may be software written in JAVA, C++, or other suitable language providing data in extensible markup language (XML) format or other suitable format. While illustrated as an integrated component of the computer (402), alternative implementations may illustrate the API (412) or the service layer (413) as stand-alone components in relation to other components of the computer (402) or other components (whether or not illustrated) that are communicably coupled to the computer (402). Moreover, any or all parts of the API (412) or the service layer (413) may be implemented as child or sub-modules of another software module, enterprise application, or hardware module without departing from the scope of this disclosure.

The computer (402) includes an interface (404). Although illustrated as a single interface (404) in FIG. 4, two or more interfaces (404) may be used according to particular needs, desires, or particular implementations of the computer (402). The interface (404) is used by the computer (402) for communicating with other systems in a distributed environment that are connected to the network (430). Generally, the interface (404 includes logic encoded in software or hardware (or a combination of software and hardware) and operable to communicate with the network (430). More specifically, the interface (404) may include software supporting one or more communication protocols associated with communications such that the network (430) or interface's hardware is operable to communicate physical signals within and outside of the illustrated computer (402).

The computer (402) includes at least one computer processor (405). Although illustrated as a single computer processor (405) in FIG. 4, two or more processors may be used according to particular needs, desires, or particular implementations of the computer (402). Generally, the computer processor (405) executes instructions and manipulates data to perform the operations of the computer (402) and any algorithms, methods, functions, processes, flows, and procedures as described in the instant disclosure.

The computer (402) also includes a memory (406) that holds data for the computer (402) or other components (or a combination of both) that can be connected to the network (430). For example, memory (406) can be a database storing data consistent with this disclosure. Although illustrated as a single memory (406) in FIG. 4, two or more memories may be used according to particular needs, desires, or particular implementations of the computer (402) and the described functionality. While memory (406) is illustrated as an integral component of the computer (402), in alternative implementations, memory (406) can be external to the computer (402).

The application (407) is an algorithmic software engine providing functionality according to particular needs, desires, or particular implementations of the computer (402), particularly with respect to functionality described in this disclosure. For example, application (407) can serve as one or more components, modules, applications, etc. Further, although illustrated as a single application (407), the application (407) may be implemented as multiple applications (407) on the computer (402). In addition, although illustrated as integral to the computer (402), in alternative implementations, the application (407) can be external to the computer (402).

There may be any number of computers (402) associated with, or external to, a computer system containing computer (402), each computer (402) communicating over network (430). Further, the term “client,” “user,” and other appropriate terminology may be used interchangeably as appropriate without departing from the scope of this disclosure. Moreover, this disclosure contemplates that many users may use one computer (402), or that one user may use multiple computers (402).

In some embodiments, the computer (402) is implemented as part of a cloud computing system. For example, a cloud computing system may include one or more remote servers along with various other cloud components, such as cloud storage units and edge servers. In particular, a cloud computing system may perform one or more computing operations without direct active management by a user device or local computer system. As such, a cloud computing system may have different functions distributed over multiple locations from a central server, which may be performed using one or more Internet connections. More specifically, a cloud computing system may operate according to one or more service models, such as infrastructure as a service (IaaS), platform as a service (PaaS), software as a service (SaaS), mobile “backend” as a service (MBaaS), serverless computing, artificial intelligence (AI) as a service (AIaaS), and/or function as a service (FaaS).

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed:

1. A tracer tool for tracking a state of a dissolvable downhole tool, the tracer tool comprising:
a medium dissolvable under downhole conditions; and
at least one tracer material embedded in the medium, and releasable from the medium during dissolution of the medium,
wherein the tracer tool is mechanically separate from the dissolvable downhole tool.

2. The tracer tool of claim 1, wherein the medium is identical to a dissolvable material of the dissolvable downhole tool.

3. The tracer tool of claim 1, wherein the medium comprises at least one selected from a degradable polymer material, a degradable elastomeric material, and a metal alloy.

4. The tracer tool of claim 1, wherein the medium prevents washout of the at least one tracer material from the medium.

5. The tracer tool of claim 1, wherein the at least one tracer material comprises a plurality of tracer materials, arranged from a periphery of the tracer tool to a center of the tracer tool in a plurality of layers.

6. The tracer tool of claim 5, wherein each of the plurality of layers contains one of the plurality of tracer materials that is distinct from other tracer materials of the plurality of tracer materials.

7. The tracer tool of claim 1, wherein the at least one tracer material comprises a plurality of tracer materials, arranged in the medium to result in a sequential release of the plurality of tracer materials over time.

8. The tracer tool of claim 1, wherein the at least one tracer material is one selected from a group consisting of an inorganic quantum dot, a carbon-based quantum dot, and a perovskite quantum dot.

9. The tracer tool of claim 8, wherein the carbon-based quantum dot is one selected from a group consisting of a carbon quantum dot, a graphene quantum dot, and a graphene oxide quantum dot.

10. The tracer tool of claim 1, wherein the at least one tracer material is a quantum dot with a peak emission wavelength in a range of 400-750 nm.

11. A method for tracking a state of a dissolvable downhole tool, the method comprising:
deploying a tracer tool in a downhole outfitted with the dissolvable downhole tool,
wherein the tracer tool comprises:
a medium dissolvable under downhole conditions, and
at least one tracer material embedded in the medium, and releasable from the medium during dissolution of the medium, and
wherein the tracer tool is mechanically separate from the dissolvable downhole tool;
performing a hydraulic fracturing operation;
determining the state of the dissolvable downhole tool by monitoring an emission spectrum of a flowback from the downhole to detect a presence of the at least one tracer material; and
based on the determining of the state, decide on a completion operation to be performed on the downhole.

12. The method of claim 11, wherein the completion operation comprises readying the downhole for production.

13. The method of claim 11, wherein the completion operation comprises milling out a remainder of the dissolvable downhole tool.

14. The method of claim 11, wherein determining the state of the dissolvable downhole tool involves detecting first emissions of the emission spectrum indicative of a presence of a first tracer material of the at least one tracer material, followed by detecting second emissions of the emission spectrum indicative of a presence of a second tracer material of the at least one tracer material.

15. The method of claim 11, wherein the monitoring of the emission spectrum of the flowback is performed above-ground.

16. A system for tracking a state of a dissolvable downhole tool, the system comprising:
a tracer tool comprising:
a medium dissolvable under downhole conditions; and
at least one tracer material embedded in the medium, and releasable from the medium during dissolution of the medium,
wherein the tracer tool is mechanically separate from the dissolvable downhole tool; and
an interrogator unit for detecting a presence of the at least one tracer material in a flowback from the downhole.

17. The system of claim 16, wherein the at least one tracer material comprises a plurality of tracer materials, arranged in the medium to result in a sequential release of the plurality of tracer materials over time.

18. The system of claim 16, wherein the at least one tracer material is one selected from a group consisting of a carbon quantum dot, a graphene quantum dot, and a graphene oxide quantum dot.

19. The system of claim 16, wherein the at least one tracer material is a quantum dot with a peak emission wavelength in a range of 400-750 nm.

20. The system of claim 16, wherein the interrogator unit is located above-ground.

21. The system of claim 16, wherein the interrogator unit comprises:
an irradiation unit exposing the flowback to light; and
a photodetector capturing an emission spectrum of the flowback exposed to the light.
